(19) United States
(12) Patent Application Publication
(10) Pub. No.: US 2021/0097550 A1
(43) Pub. Date: Apr. 1, 2021

(54) DONOR-FUNDED RESTRICTED LINE OF CREDIT

(71) Applicant: Bank of America Corporation, Charlotte, NC (US)

(72) Inventors: Tamara S. Kingston, Peoria, AZ (US); Maria Carolina Barraza Enciso, New York, NY (US); Karen Wiles, San Antonio, TX (US); Rebecca S. Morgan, Charlottesville, VA (US); Elena Kvochko, New York, NY (US)

(21) Appl. No.: 16/583,556

(22) Filed: Sep. 26, 2019

(51) Int. Cl. G06Q 20/42; G06Q 20/40; G06Q 20/24; G06Q 20/02; G06Q 40/02; G06Q 20/26

(52) U.S. Cl. CPC G06Q 20/42; G06Q 20/405; G06Q 20/26; G06Q 20/023; G06Q 40/025; G06Q 20/24

(57) ABSTRACT

Apparatus and methods for providing a donor-funded restricted line of credit to a customer. The restricted line of credit may be available to the customer only for credit card purchases associated with a donor-selected MCC. The method may include a bank account performing the method steps of storing funds transferred to the bank account by a donor. The method may also include tagging at least a portion of the funds with the donor-selected MCC. The method may further include a banking portal performing the method steps of displaying, to the customer, a value of the stored funds in the bank account and the portion of the funds tagged with the donor-selected MCC. The methods may additionally include not providing the customer with means to access or withdraw the funds from the bank account other than through authorized purchases with the credit card.

### FIELD OF TECHNOLOGY

Aspects of the disclosure relate apparatus and methods for providing a donor-funded restricted line of credit. Specifically, aspects of the disclosure relate to a donor-funded restricted line of credit accessible to a customer when using a credit card.

### BACKGROUND

Mobile devices, such as smartphones are ubiquitous tools. Mobile devices are used for a variety of purposes, including social and work-related tasks. For example, socially, mobile devices are used for communication among friends. Friends that live geographically apart and would otherwise not be able to regularly speak or see each other may, using their mobile devices, be in regular contact with each other.

For example, friends may form group chats or other virtual groups where they may communicate and update each other on life events. Using their mobile devices, friends can easily share career accomplishments, life challenges, or appeal to their close circle of acquaintances for advice or other assistance.

Because friends are now typically in regular contact with each other, an appeal for help by one friend may elicit sympathy and a desire by the other friends to take action to provide needed assistance. For example, based on prior communications, friends may be aware that one member of their group is in need of financial assistance. They may be aware of this need, not because the friend has expressly asked for help. Rather, they may be aware of the need as a result of observing shared communications that reflect lifestyle changes or other events that provide contextual clues. Exemplary lifestyle changes may include moving to reduce housing costs or looking for a new job. Other contextual events may include comments or posted pictures that indicate a change in spending habits or use of charitable services.

Because friends may be more aware of each other's needs they may wish to help each other. However, friends may feel more motivated to help when they there are systems and methods to assure them that their donated funds will be used for their friend's need, and not misused or misappropriated by the friend or a relative of the friend.

It would be desirable to provide a system and apparatus that allows friends to provide assistance to each other by enhancing functionality of payment instruments already in use by the friend in need. It would be desirable to provide a system and apparatus that allows donors to provide assistance to a donee in a manner that maintains the dignity of the donee. Maintaining the dignity of a donee includes providing access to donated funds in manner that is indiscernible to an onlooker.

It would be desirable, therefore, to provide systems and methods for providing a line of credit to an individual that can only be used for predefined goods and services.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus that may be used in accordance with the invention;

FIG. 2 shows an illustrative method in accordance with the invention;

FIG. 3 shows an illustrative graphical user interface in accordance with the invention; and

FIG. 4 shows illustrative apparatus that may be used in accordance with the invention.

### DETAILED DESCRIPTION

Apparatus and methods for supporting a credit card having a restricted line of credit are provided. The credit card may be used by a customer. The value of the credit card's line of credit may be dynamically determined, on a real-time basis, based on a value of funds in a bank account. The funds in the bank account may be donated to the customer by one, two or more donors.

A donor may transmit funds to the bank account using the donor's online banking portal, a charity website, a mobile application, or any other suitable method. To transfer the funds, the donor may input data identifying the customer.

The methods may include providing the donor-funded restricted line of credit to the customer. The restricted line of credit may be available to the customer for credit card purchases with a credit card only when the credit card purchase is associated with a Merchant Category Code (“MCC”) included in a predetermined group of MCCs.

An MCC may be assigned to a merchant who provides a Point of Sale (“POS”) terminal at which a credit card purchase is performed. The MCC may be assigned based on products sold by the merchant. The MCC may classify a merchant based on a primary line of business.

For example, the merchant may be assigned the MCC based on whether the merchant provides predominately goods or provides predominately services. If a merchant provides both goods and services, the MCC assigned to the merchant may correspond to the greater portion of the merchant's business.

The MCC may be associated with a taxation status. For example, if the MCC corresponds to a provider of services, a customer that purchases services from the merchant may not be required to report payments for the services to a government agency.

The MCC may be assigned by the acquirer. The acquirer may assign the MCC to the merchant at a time the merchant agrees to accept the payment instrument as a form of payment. The acquirer may assign the MCC to the merchant in response to the merchant agreeing to accept the payment instrument as a form of payment.

The merchant may be assigned multiple MCCs. For example, the merchant may provide pharmacy products and grocery products. The pharmacy products may be assigned a first MCC and the grocery products may be assigned a second MCC.

The MCC may classify the merchant based on a market segment serviced by the merchant. Exemplary MCCs and associated market segment are shown in Table 1.

TABLE 1
Illustrative MCCs and associated market segments.

| Illustrative Merchant | |
|---|---|
| Category Code (“MCC”) | Illustrative Associated Market Segment |
| 0742 | Veterinary Services |
| 4214 | Motor Freight Carriers and Trucking - Local |
| | and Long Distance, Moving and Storage |
| | Companies, and Local Delivery Services |
| 4812 | Telecommunication Equipment and |
| | Telephone Sales |
| 5047 | Medical, Dental, Ophthalmic, and Hospital |
| | Equipment and Supplies |
| 5172 | Petroleum and Petroleum Products |
| 5718 | Fireplace, Fireplace Screens, and Accessories |
| | Stores |

The methods may include a dynamic MCC budget assignor platform. The platform may determine how the customer can use the donated funds. The platform may divide the donated funds into groups of funds. The platform may assign an MCC to each group of funds. The customer's credit card may then only be used for purchases with an MCC that is associated with one of the group of funds. Additionally, a purchase with an MCC may only be authenticated as long as the purchase value is equal to or less than the value of the group of funds associated with that same MCC in the bank account.

The methods may include the dynamic MCC budget assignor platform collecting prior spend history of the customer. The prior spend history may include credit card purchase history of the customer, debit card purchase history of the customer and/or electronic withdrawals from a bank account of the customer.

The methods may include the dynamic MCC budget assignor platform identifying a geolocation of the customer.

The methods may include the dynamic MCC budget assignor platform retrieving a marital status of the customer.

The methods may include the dynamic MCC budget assignor platform collecting network messages associated with a social media account of the customer. The methods may include the platform analyzing the network messages for one or more predetermined terms, at least one of the predetermined terms indicating distress.

The methods may include determining, based on the prior spend history, the geolocation, the martial status and/or whether or not the one or more predetermined terms are identified at least a threshold number of times, a budget for the customer. The budget may include the predetermined group of MCCs. For each MCC in the group, the budget may include a value of funds for being spent on purchases associated with the MCC during a predetermined time period. Thus, the platform may divide the donated funds stored in the bank account into groups of funds and assign to each group of funds an MCC for which the associated group of funds can be spent.

The methods may include a bank account for storing funds transferred to the bank account by a donor. The methods may include the bank account, based on the budget, dividing the stored funds into groups of funds, and tagging each group with an MCC included in the group of MCCs, by running the dynamic MCC budget assignor platform.

The methods may include the bank account not providing the customer means to access or withdraw the funds stored in the bank account other than through authorized purchases with the credit card. This may ensure that the donor funds are used as determined best by the dynamic MCC budget assignor platform and are not misappropriated in any way.

The methods may include a banking portal displaying, to the customer, a value of the stored funds in the bank account. The methods may include the banking portal displaying, to the customer, values of the groups of funds and the MCCs tagged to each group of funds. In some embodiments, the banking portal display may be a read-only display. The read-only display may not be modified by a customer selection.

The methods may include the credit card providing a line of credit to the customer. The value of the line of credit may be a value of the funds stored in the bank account. As funds are deposited into the bank account, and as funds are put on hold (for having been used for credit card purchases) and/or withdrawn from the bank account to pay authorized credit card purchases, the value of the line of credit may change.

The methods may include a credit card processing platform receiving from a merchant bank a purchase authorization request including information identifying the credit card, a purchase amount and a purchase MCC. The methods may include the credit card processing platform determining if the purchase MCC is included in the group of MCCs. If the purchase MCC is included in the group of MCCs and the purchase amount is less than or equal to a value of funds tagged to the purchase MCC in the bank account, the methods may include the credit card processing platform sending a message to the merchant approving the transaction.

The methods may include the bank account, upon the lapse of a predetermined time period, returning to the donor(s) any donor funds remaining in the bank account.

The methods may include the bank account automatically paying the purchase amount to the merchant bank by initiating a transfer of funds from the bank account to the merchant bank, for example using a monthly credit card auto-pay feature. The automatically paying may include initiating an automated clearing house (“ACH”) transfer of funds from the bank account to the merchant bank.

The methods may include the credit card processing platform sending a message to the merchant denying the transaction if the purchase MCC is not included in the group of MCCs. In some embodiments, instead of a denial of the transaction, the credit card processing platform may authenticate the transaction and initiate an alert to the customer and/or to the donor that the customer has engaged in a purchase greater than the donor-allocated amount.

The methods may include the credit card processing platform sending a message to the merchant denying the transaction if the purchase amount is greater than the funds tagged to the purchase MCC in the bank account. In some embodiments, instead of a denial of the transaction, the credit card processing platform may authenticate the transaction and initiate an alert to the customer and/or to the donor that the customer has engaged in a purchase greater than the donor-allocated amount.

In some embodiments, the bank account may be a first bank account. The first bank account may be linked to a second bank account. In some of these embodiments, the credit card processing platform may determine that the purchase MCC is included in the group of MCCs. The credit card processing platform may also determine that the purchase amount is greater than the funds tagged to purchase MCC by a predetermined amount. The predetermined amount may be less than a threshold value. The threshold value may be fifty cents, one dollar, two dollars, five dollars, ten dollars, twenty dollars, or any other suitable amount.

In response to the determination, the credit card processing platform may send a message to the merchant to authorize the transaction. The credit card processing platform may then instruct the second bank account to pay the difference between the purchase amount and the tagged funds. The methods may include the second bank account transferring, into the first bank account, the difference between the purchase amount and the value of the tagged funds. The second bank account may be a bank account of the donor. The second bank account may be a bank account of a charitable organization. The second bank account may be a bank account of a financial institution. These methods may ensure that a customer is able to process a transaction for an MCC included in the group of MCCs even if the purchase value is above the tagged funds by an amount that may be a nominal amount.

Apparatus and methods of the invention may include a method for providing the donor-funded restricted line of credit to the customer. The restricted line of credit may be available to the customer only for credit card purchases associated with a donor-selected MCC.

The donor may select the MCC to which the customer's purchases are restricted by selecting an icon or inputting information into an input field. The donor may transmit the funds and/or select the MCC using one or more GUIs displayed on the donor's online banking portal, on a charity website or any other suitable website, a mobile application, or any other suitable method. The donor may additionally input data identifying the customer to whom the donor desires to donate the funds.

Although the invention is described below as including a single MCC, a donor may select two or more MCCs to which the customer's purchases are restricted. Additionally, two or more donors may donate funds to the bank account accessible to the customer via the donor-funded restricted credit card.

When there are multiple MCCs, each donor may select the MCCs he wants his funds to be used for and also allocate an amount of funds to be allocated to each of his selected MCC. The bank account may then tag the allocated amounts of funds with the corresponding MCC. When a transaction is executed by a customer for an MCC, the bank account may reduce the value of funds now available to be spent for that MCC by the purchase amount of the transaction.

The methods may include a bank account performing the method steps of storing funds transferred to the bank account by a donor. The methods may include tagging at least a portion of the funds with the donor-selected MCC.

The methods may also include not providing the customer with means to access or withdraw the funds from the bank account other than via authorized purchases with the credit card. This may ensure that the donor funds are used as desired by the donor (i.e. based on the donor-selected MCC) and are not misappropriated in any way.

The methods may include a banking portal performing the method steps of displaying, to the customer, a value of the stored funds in the bank account. The methods may include the banking portal displaying to the customer the value of the funds tagged with the donor-selected MCC. In some embodiments, all the stored funds in the bank account may be tagged with the donor-selected MCC. In the embodiments when the donor has selected two or more MCCs, the banking portal may display the two or more MCCs and the value of the funds tagged to each of the displayed two or more MCCs. In some embodiments, banking portal display may be a read-only display. The read-only display may be a display that cannot be modified by a customer selection.

The methods may include the credit card providing a line of credit to the customer. The total value of the line of credit may be a total value of the funds stored in the bank account. When there is one donor-selected MCC, the total value of the line of credit may be available to the customer for use only for purchases associated with the donor-selected MCC.

When there are two or more donor-selected MCCs, the total value of the line of credit may be available to the customer for use only for purchases associated with the two or more donor-selected MCCs. Additionally, the total value of the line of credit may be split between the two or more donor-selected MCCs. Thus, the total value of the line of credit would not be able to be use up on one of the two or more MCCs.

The methods may include a credit card processing platform receiving from a merchant bank a purchase authorization request. The purchase authorization request may include information identifying the credit card, a purchase amount and a purchase MCC. The methods may include the credit card processing platform determining if the purchase MCC is the donor-selected MCC.

If the purchase MCC is determined to be the donor-selected MCC and the purchase amount is determined to be less than or equal to the funds tagged with the donor-selected MCC, the methods may include the credit card processing platform sending a message to the merchant approving the transaction.

In some embodiments, the bank account may be a first bank account. The first bank account may be linked to a second bank account. In some of these embodiments, the credit card processing platform may determine that the purchase MCC is the donor-selected MCC. The credit card processing platform may also determine that the purchase amount is greater than the funds tagged to the donor-selected MCC by a predetermined amount. The predetermined amount may be less than a threshold value. The threshold value may be fifty cents, one dollar, two dollars, five dollars, ten dollars, twenty dollars, or any other suitable amount.

In response to the determination, the credit card processing platform may send a message to the merchant to authorize the transaction. The credit card processing platform may then instruct the second bank account to pay the difference between the purchase amount and the tagged funds. The methods may include the second bank account transferring, into the first bank account, the difference between the purchase amount and the value of the tagged funds. The second bank account may be a bank account of the donor. The second bank account may be a bank account of a charitable organization. The second bank account may be a bank account of a financial institution. These methods may ensure that a customer is able to process a transaction for a donor-selected MCC even if the purchase value is above the tagged funds by an amount that may be a nominal amount.

The methods may include the credit card processing platform sending a message to the merchant denying the transaction if the purchase MCC not the same as the donor-selected MCC. In some embodiments, instead of a denial of the transaction, the credit card processing platform may authenticate the transaction and initiate an alert to the customer and/or to the donor that the customer has engaged in a purchase greater than the donor-allocated amount.

The methods may include the credit card processing platform sending a message to the merchant denying the transaction if the purchase amount is greater than the funds tagged to the donor-selected MCC. In some embodiments, instead of a denial of the transaction, the credit card processing platform may authenticate the transaction and initiate an alert to the customer and/or to the donor that the customer has engaged in a purchase greater than the donor-allocated amount.

The methods may include the bank account automatically paying the purchase amount to the merchant bank by initiating a transfer of funds from the bank account to the merchant bank. The bank account may automatically pay the purchase amount by initiating an ACH transfer of funds from the bank account to the merchant bank.

In some embodiments, the bank account may be a temporary bank account. In some of these embodiments, upon the lapse of a predetermined time period, the bank account may return to the donor any donor funds remaining in the bank account.

In some embodiments, the donor-selected MCC may be one of a plurality of donor-selected MCCs, as described above. In some of these embodiments, the bank account may perform the method steps of dividing the funds into a plurality of groups of funds as per the donor's instructions, and tagging each group of funds with one of the plurality of donor-selected MCCs.

In some embodiments, as described above, the donor may be one of two or more donors. In these embodiments, each of the two or more donors may transfer funds to the bank account. In some of these embodiments, the MCC may be one of two or more MCCs. Each of the two or more MCCs being may be tagged to some of the funds stored in the bank account. Each donor may select, for the funds that she/he transfers to the bank account: (1) which MCCs he/she wants the funds to be used for; and (2) the value of his donated funds that she/he wants to be used for each of the identified MCCs.

Apparatus and methods of the invention may include a system architecture for providing the donor-funded restricted credit card to the customer. The system architecture may include one, two, some or all of the dynamic MCC budget assignor platform, the bank account, the credit card processing platform, and the banking portal. The system architecture may include the aforementioned apparatus performing one or more of the methods described above.

Apparatus and methods of the invention may include a system architecture for providing the donor-funded restricted debit card to the customer. The donor-funded restricted debit card may be available for use by the customer only for debit card purchases associated with one or more donor-selected Merchant Category Code (“MCC”), as described above, and/or for debit card purchases associated with one or more MCCs identified by the MCC budget assignor platform as described above.

The system architecture may include a bank account for storing funds for withdrawal by the debit card. The bank account may perform the steps of receiving and storing funds transferred to the bank account by a donor. The bank account may perform the steps of associating a donor-selected MCC or a MCC budget assignor platform assigned MCC with the funds. The bank account may perform the steps of not providing the customer means to access or withdraw the funds from the bank account other than via authorized purchases with the debit card.

The system architecture may include a banking portal. The banking portal may be associated with the bank account. The banking portal may display, to the customer, a value of the stored funds in the bank account. The banking portal may display, to the customer, the donor-selected MCC associated with the funds.

The system architecture may include a credit card processing platform for performing the step of receiving from a merchant bank a purchase authorization request including information identifying the debit card, a purchase amount and a purchase MCC. The credit card processing platform may perform the step of determining if the purchase MCC is the donor-selected MCC.

If the purchase MCC is determined to be the donor-selected MCC and the purchase amount is less than or equal to funds associated with the donor-selected MCC, the credit card processing platform may send a message to the merchant approving the transaction. Additional decisioning described herein regarding whether or not to authenticate a purchase authorization request may be performed by the credit card processing platform.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Specifically, the bank account, the dynamic MCC budget assignor platform, the credit card processing platform, the merchant bank, the banking portal, and the other apparatus described herein may be embodied in whole or in part as a method, a data processing system, or a computer program product. Accordingly, the invention, and one or more of the bank account, the dynamic MCC budget assignor platform, the credit card processing platform, the merchant bank, the banking portal, and the other apparatus described herein may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g. air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

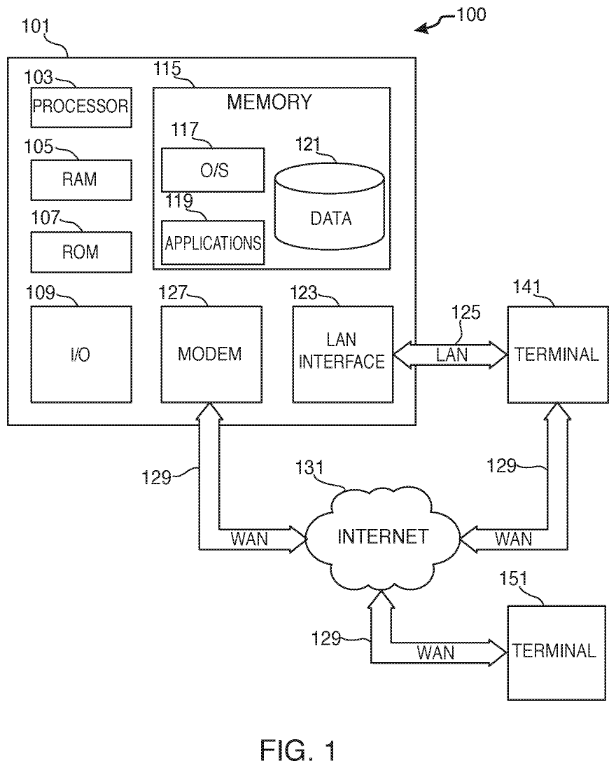

FIG. 1 is a block diagram that illustrates a generic computing device 101 that may be used according to an illustrative embodiment of the invention. Specifically, the bank account, the dynamic MCC budget assignor platform, the credit card processing platform, the merchant bank, the banking portal, and other apparatus described herein may include some or all of the apparatus described with respect to generic computing device 101.

Computing device 101 may have a processor 103 for controlling overall operation of the server and its associated components, including RAM 105, ROM 107, input/output module 109, and memory 115. Computing device 101 may include one or more receiver modules, server modules and processors that may be configured to transmit and receive payments, wire transfers, payments via checks, debit cards, credit cards, lines of credit or any suitable credit instrument. Likewise, computing device 101 may be configured to transmit and/or receive information and to provide information or commands from/to any suitable system. Further, computing device 101 may provide confirmation to one or more payees and facilitate payment approval processing and perform any other suitable tasks related to treasury operation within a cash positioning and reporting system. Additionally, computing device 101 may provide confirmation to mobile devices or terminals 141, 151 which implement the invention.

Input/output (“I/O”) module 109 may include a microphone, keypad, touch screen, and/or stylus through which a user of computing device 101 may provide input, and may also include one or more speakers for providing audio output and a video display device for providing textual, audiovisual and/or graphical output. The touch screen may also serve as a video display device. The touch screen may respond to “gestures”—e.g. a double tap may open an item and a pinching motion may shrink an item. The touch screen in combination with the video display may be referred to as the “display” of the device.

Software may be stored within memory 115 to provide instructions to processor 103 for enabling computing device 101 to perform various functions. For example, memory 115 may store software used by computing device 101, such as an operating system 117, application programs 119, and an associated database 121. Alternatively, some or all of computing device 101 computer executable instructions may be embodied in hardware or firmware (not shown). As described in detail below, database 121 may provide storage for customer information, invoices, approvals, MCC codes, various types of confirmations and any other suitable information.

Computing device 101 may operate in a networked environment supporting connections to one or more remote computers, such as mobile devices 141 and 151. Mobile devices 141 and 151 may be personal computers or servers that include many or all of the elements described above relative to computing device 101.

The network connections depicted in FIG. 1 include a local area network (LAN) 125 and a wide area network (WAN) 129, but may also include other networks. When used in a LAN networking environment, computing device 101 is connected to LAN 125 through a network interface or adapter 123. When used in a WAN networking environment, computing device 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. Both computing device 101 and mobile devices 141 and 151 may include networking hardware, networking software or a combination of hardware and software which enables communication over local area network (LAN) 125 and a wide area network (WAN) 129.

Additionally, application program 119, which may be used by computing device 101, may include computer executable instructions for invoking user functionality related to communication, such as email, short message service (SMS), and voice input and speech recognition applications.

Computing device 101 and/or mobile devices 141, 151 may also be mobile terminals including various other components, such as a battery, speaker, and antennas (not shown).

Computing device 101, terminal 151 and/or terminal 141 may be portable devices such as a laptop, cell phone, Blackberry™, smartphone, iPad™, iPhone™, Kindle™ or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: determining an MCC budget for a customer, creating and maintaining the bank account, determining whether or not to authorize or deny a purchase request for the restricted credit card or the debit card in accordance with the invention, and any other methods described herein.

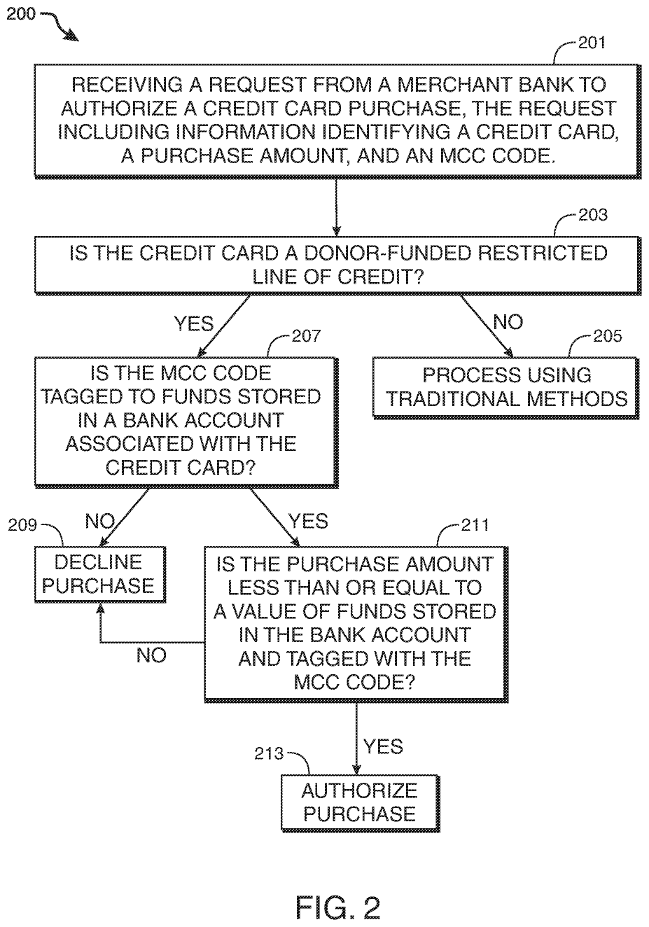

FIG. 2 shows illustrative method 200 that may be performed in accordance with the invention. The method may be performed by a credit card processing platform. The credit card processing platform may be a platform supported by the institution that issued the donor-funded restricted line-of-credit credit card to a customer. At step 201, the platform may receive a request from a merchant bank to authorize a credit card purchase. The request may include information identifying a credit card, a purchase amount and an MCC.

At step 203, the platform may determine whether or not the credit card is a donor-funded restricted line-of-credit credit card. If not, then, at step 205, the platform may process the request using conventional methods. If yes, then, at step 207, the platform may determine if the MCC received is tagged to funds stored in a bank account associated with the credit card.

If not, then, at step 209, the platform may decline the purchase. If yes, then, at step 211, the platform may determine if the purchase amount is less than or equal to a value of funds stored in the bank account and tagged with the MCC. If not, then, at step 209, the platform may deny the purchase. If yes, then, at step 212, the platform may authorize the purchase.

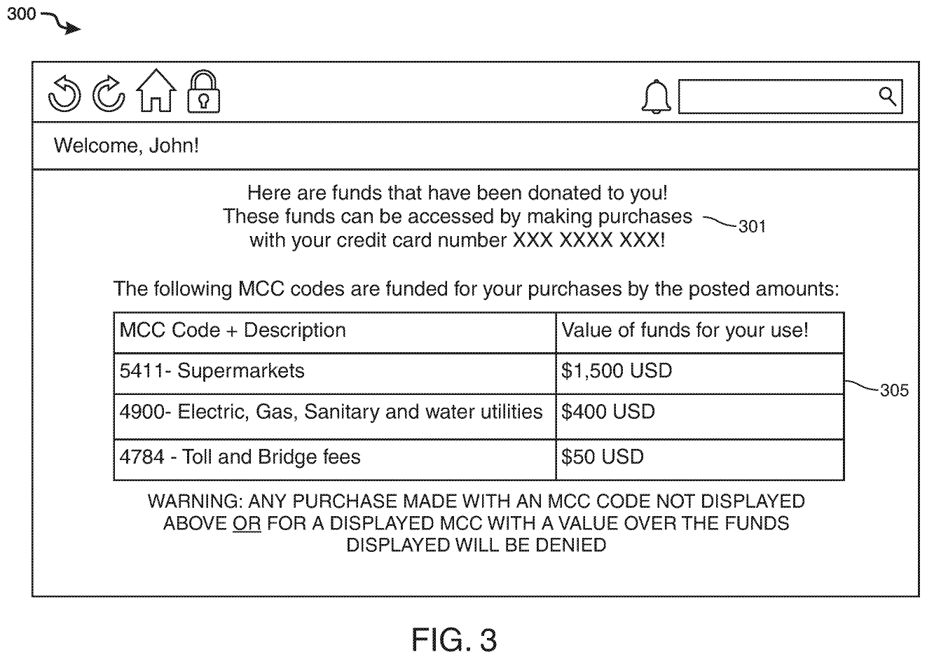

FIG. 3 shows illustrative GUI 300 that may be displayed to a customer. The customer may be the recipient of the donor-funded restricted line of credit. GUI 300 may display credit card number 301. Credit card number 301 may be a credit card number of a donor-funded restricted line-of-credit credit card. GUI 300 may also display one or more MCC and Description 303. MCC and Description 303 may display MCCs to which donor funds have been allocated. GUI 300 may additionally display Value of Funds for Your Use 305. Value of Funds for Your Use 305 may display, for each MCC funded, the amount of funds available to be spent.

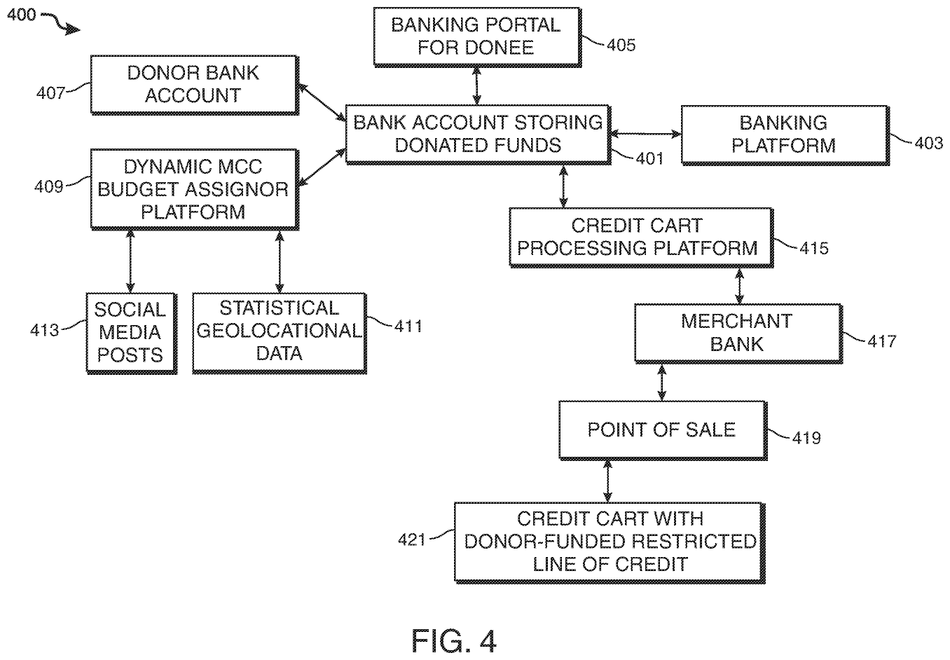

FIG. 4 shows illustrative apparatus that may be used with systems and methods of the invention. Illustrative apparatus may include one, two, or more, a subset of, or all of, the apparatus illustrated in FIG. 4. The apparatus shown in FIG. 4 may include some or all of the hardware illustrated in FIG. 1. Communications between apparatus illustrated in FIG. 4 may be supported by internet communications, near-field communications, telephone-wire communications, blue booth communications, or any other suitable communications.

Illustrative apparatus may include Bank Account Storing Donated funds 401, which may be linked to, and supported by, Banking Platform 403. Illustrative apparatus may include Banking Portal for Donee 405, Donor Bank Account 407 and/or Dynamic MCC Budget Assignor Platform 409. Dynamic MCC Budget Assignor Platform 409 may be in electronic communication with one or more of Social Media Posts 413 (which may be displayed on one or more social media websites) and/or Statistical Correlational Data 411 which may provide statistics and algorithms for using geographical data, marital status data, social media data, and any other data when determining a MCC budget for a customer.

Illustrative apparatus may include Credit Card Processing Platform 415, which may be in communication with Merchant Bank 417. Merchant Bank 417 may be in communication with Point of Sale 419. Credit Card with Donor-Funded Restricted Line of Credit 421 may be used by the customer to transact a purchase at Point of Sale 419. Point of Sale 419 may transmit purchase data to Merchant Bank 417, which may forward the data via a credit card processing network to Credit Card Processing Platform 415.

When Credit Card Processing Platform 415 determines that the credit card attempting the purchase is Credit Card with Donor-Funded Restricted Line of Credit 421, Credit Card Processing Platform 415 may communicate with Banking Platform 403 via Bank Account Storing Donated Funds 401 to determine if the purchase should be approved or denied. For example, if the purchase is associated with an MCC stored in the Bank Account Storing Donated Funds 401 and the purchase amount is less than or equal to a value of funds tagged with the MCC, Credit Card Processing Platform 415 may authenticate the transaction. If the purchase is not associated with an MCC stored in the Bank Account Storing Donated Funds 401 and/or if the purchase amount is greater than a value of funds tagged with the MCC, Credit Card Processing Platform 415 may deny the transaction.

Thus, systems and methods for providing a donor-funded restricted line of credit have been provided. Persons skilled in the art will appreciate that the present invention can be practiced by other than the described embodiments, which are presented for purposes of illustration rather than of limitation.

What is claimed is:

1. A method for providing a donor-funded restricted line of credit to a customer, the restricted line of credit being available to the customer for credit card purchases with a credit card only when the credit card purchase is associated with a Merchant Category Code (“MCC”) included in a predetermined group of MCCs, the method comprising:
a dynamic MCC budget assignor platform for performing the method steps of:
collecting prior spend history of the customer, the prior spend history including credit card purchase history of the customer, debit card purchase history of the customer, and electronic withdrawals from a bank account of the customer;
identifying a geolocation of the customer;
retrieving a marital status of the customer;
collecting network messages associated with a social media account of the customer and analyzing the network messages for one or more predetermined terms, at least one of the predetermined terms indicating distress; and
determining, based on the prior spend history, the geolocation, the martial status, and whether or not the one or more predetermined terms are identified at least a threshold number of times, a budget for the customer, the budget including the predetermined group of MCCs and, for each MCC in the group, a group of funds for being spent on purchases associated with the MCC during a predetermined time period;
a bank account performing the method steps of:
storing funds transferred to the bank account by a donor; and
based on the budget, dividing the stored funds into groups of funds, and tagging each group of funds with an MCC included in the group of MCCs; and
a credit card processing platform performing the method steps of:
receiving from a merchant bank a purchase authorization request including information identifying the credit card, a purchase amount and a purchase MCC;
determining if the purchase MCC is included in group of MCCs; and
if the purchase MCC is included in the group of MCCs and the purchase amount is less than or equal to a value of funds included in the group of funds tagged to the purchase MCC in the bank account, sending a message to the merchant approving the transaction.

2. The method of claim 1 further comprising:
the bank account performing the method steps of not providing the customer means to access or withdraw the funds stored in the bank account other than through authorized purchases with the credit card; and
a banking portal performing the method steps of displaying, to the customer, a value of the stored funds in the bank account, values of the groups of funds and the MCCs tagged to each group of funds.

3. The method of claim 1 further comprising the bank account performing the method steps of, upon the lapse of a predetermined time period, returning to the donor any donor funds remaining in the bank account.

4. The method of claim 3 wherein the displaying to the customer is a read-only display that cannot be modified by a customer selection.

5. The method of claim 1 further comprising the bank account performing the method steps of automatically paying the purchase amount to the merchant bank by initiating a transfer of funds from the bank account to the merchant bank, wherein:
the automatically paying includes initiating an automated clearing house (“ACH”) transfer of funds from the bank account to the merchant bank.

6. The method of claim 1 further comprising the credit card performing the method steps of providing a line of credit to the customer, the value of the line of credit being the value of the funds stored in the bank account.

7. The method of claim 1 further comprising the credit card processing platform for performing the methods steps of:
sending a message to the merchant denying the transaction if the purchase MCC is not included in the group of MCCs; and
sending a message to the merchant denying the transaction if the purchase amount is greater than funds associated with the purchase MCC in the bank account.

8. The method of claim 1 wherein:
the bank account is a first bank account and is linked to a second bank account;
the credit card processing platform performs the method steps of:
determining that the purchase amount is greater than the amount of funds tagged to the purchase MCC in the bank account by a predetermined amount;
sending a message to the merchant to authorize the transaction; and
the second bank account performs the method steps of transferring, into the first bank account, the difference between the purchase amount and the funds tagged to the purchase MCC in the bank account.

9. The method of claim 8 wherein the second bank account is a bank account of the donor.

10. A method for providing a donor-funded restricted line of credit to a customer, the restricted line of credit being available to the customer only for credit card purchases associated with a donor-selected Merchant Category Code (“MCC”), the method comprising:
a bank account performing the method steps of:
storing funds transferred to the bank account by a donor;
tagging at least a portion of the funds with the donor-selected MCC; and
not providing the customer means to access or withdraw the funds from the bank account other than via authorized purchases with the credit card;
a banking portal performing the method steps of:
displaying, to the customer, a value of the stored funds in the bank account and the funds tagged with the donor-selected MCC;
a credit card processing platform performing the method steps of:
receiving from a merchant bank a purchase authorization request including information identifying the credit card, a purchase amount and a purchase MCC;
determining if the purchase MCC is the donor-selected MCC; and
if the purchase MCC is determined to be the donor-selected MCC and the purchase amount is less than or equal to the funds tagged with the donor-selected MCC, sending a message to the merchant approving the transaction; and
the bank account performing the method steps of automatically paying the purchase amount to the merchant bank by initiating a transfer of funds from the bank account to the merchant bank.

11. The method of claim 10 further comprising the bank account performing the method steps of, upon the lapse of a predetermined time period, returning to the donor any donor funds remaining in the bank account.

12. The method of claim 10 wherein the automatically paying includes initiating an automated clearing house (“ACH”) transfer of funds from the bank account to the merchant bank.

13. The method of claim 10 wherein the displaying, to the customer, is a read-only display that cannot be modified by a customer selection.

14. The method of claim 10 wherein:
the donor-selected MCC is one of a plurality of donor-selected MCCs; and
the bank account performs the method steps of dividing the funds into a plurality of groups of funds and tagging each group of funds with one of the plurality of donor-selected MCCs.

15. The method of claim 10 further comprising the credit card performing the method steps of providing a line of credit to the customer, the value of the line of credit being the value of the funds stored in the bank account.

16. The method of claim 10 wherein:
the donor is one of two or more donors, each of the two or more donors transferring funds to the bank account; and
the MCC is one of two or more MCCs, each of the two or more MCCs being associated with a group of the stored funds.

17. The method of claim 10 further comprising the credit card processing platform for performing the methods steps of:
sending a message to the merchant denying the transaction if the purchase MCC not the same as the donor-selected MCC; and
sending a message to the merchant denying the transaction if the purchase amount is greater than the funds tagged to the donor-selected MCC.

18. The method of claim 10 wherein:
the bank account is a first bank account and is linked to a second bank account;
the credit card processing platform performs the method steps of:
determining that the purchase MCC is the donor-selected MCC;
determining that the purchase amount is greater than the funds tagged to the donor-selected MCC by a predetermined amount, the predetermined amount being less than a threshold value; and
sending a message to the merchant to authorize the transaction; and
the second bank account performs the method steps of transferring, into the first bank account, the difference between the purchase amount and the value of the funds tagged to the donor-selected MCC.

19. The method of claim 18 wherein the second bank account is a bank account of the donor.

20. A system architecture for providing a donor-funded restricted debit card to a customer, the debit card being available for use by the customer only for debit card purchases associated with a donor-selected Merchant Category Code (“MCC”), the system architecture comprising:
a bank account for storing funds for withdrawal by the debit card, the bank account for:
receiving and storing funds transferred to the bank account by a donor;
associating a donor-selected MCC with the funds; and
not providing the customer means to access or withdraw the funds from the bank account other than via authorized purchases with the debit card;
a banking portal associated with the bank account for displaying, to the customer, a value of the stored funds in the bank account and the donor-selected MCC associated with the funds; and
a credit card processing platform performing the method steps of:
receiving from a merchant bank a purchase authorization request including information identifying the debit card, a purchase amount and a purchase MCC;
determining if the purchase MCC is the donor-selected MCC; and
if the purchase MCC is determined to be the donor-selected MCC and the purchase amount is less than or equal to funds associated with the donor-selected MCC, sending a message to the merchant approving the transaction.
